(19) United States
(12) Patent Application Publication
(10) Pub. No.: US 2025/0274032 A1
(43) Pub. Date: Aug. 28, 2025

(54) METHOD FOR CONTROLLING PULSE WITH MODULATION INVERTERS

(71) Applicant: VESTAS WIND SYSTEMS A/S, Aarhus N (DK)

(72) Inventors: John Godsk NIELSEN, Hornslet (DK); Lars HELLE, Suldrup (DK); Ionut TRINTIS, Østbirk (DK)

(21) Appl. No.: 18/878,780

(22) PCT Filed: Jun. 22, 2023
(86) PCT No.: PCT/DK2023/050162

§ 371 Date: Dec. 24, 2024

(30) Foreign Application Priority Data
Jun. 24, 2022 (DK) PA202270338

(51) Int. Cl. H02M 1/08; H02M 7/53

(52) U.S. Cl. CPC H02M 1/08; H02M 7/53

(57) ABSTRACT

The invention relates to a method for controlling one or more PWM inverters. The method comprises determining first and second periods of the first PWM inverter for operating the first PWM inverter with respective first and second switching patterns wherein the first and second switching patterns have different harmonic spectrums, and operating the first PWM inverter with the first and second switching patterns applied successively during the respective first and second periods.

### FIELD OF THE INVENTION

The invention relates to control of pulse with modulation inverters, such as pulse with modulation inverters in wind turbines.

### BACKGROUND OF THE INVENTION

Grid connected pulse-width modulation (PWM) inverters are used to convert DC electric power to AC electric power so that the AC electric power can be injected to the grid. The inverters generate the AC electric power by switching the DC power dependent on a switching signal comprising a switching pattern.

For example wind turbines generate DC power via an AC-DC converter and solar plants generate DC power which needs to be converted to an AC power.

The switching signal comprises high frequency components which are inevitably injected to grid as harmonic current emissions.

Grid codes may set requirements to the harmonic current emissions such as harmonic current emission limits for each harmonic current frequency component.

Accordingly, there is a need for improving PWM inverter systems so that they are better able to satisfy harmonic current emission requirements of grid codes.

### SUMMARY

It is an object of the invention to improve PWM inverters or control of PWM inverters so that they are able to satisfy harmonic current emission requirements of grid codes. It is also an object of the invention to provide a method of controlling PWM inverters with respect to harmonic current emission control that does not complicate such control methods. Particularly, it is an object of the invention to provide such control methods for wind turbines and wind turbine plants.

In a first aspect of the invention, a method for controlling at least a first PWM inverter is presented, the method comprises determining first and second periods of the first PWM inverter for operating the first PWM inverter with respective first and second switching patterns wherein the first and second switching patterns have different harmonic spectrums, and
operating the first PWM inverter with the first and second switching patterns applied successively during the respective first and second periods.

The method comprises controlling at least first and second PWM inverters and the method further comprises determining first and second periods of the second PWM inverter for operating the second PWM inverter with the respective first and second switching patterns, and operating the second PWM inverter with the first and second switching patterns applied successively during the respective first and second periods of the second PWM inverter. The first period of the first PWM inverter and the first period of the second PWM inverter are started at different start times.

Advantageously, by operating the PWM converter repeatedly with different switching patterns, such as alternately in case of only two different switching patterns, during periods associated with the different switching patterns, which periods are therefore also repeated continually, the different harmonic current emissions from the different switching patterns result in a reduction of harmonic current emissions at a given frequency or within a given spectral range, at least within a given period of time comprising at least the length of one of the first and second periods as compared with operating the PWM converter with a single switching pattern.

Advantageously, since only the switching method is modified, i.e. the method does not require modifications of the inverters themselves or grid filters, the control method is simple to implement. For example, the switching patterns can be designed so that existing grid filters can be used.

The same advantages for operating a single PWM converter with different switching patterns are obtained when the different switching patterns are used for operating two or more PWM converters.

Accordingly, the first and second switching patters are applied during first and second periods, respectively, so that the first and second periods for the first PWM inverter are shifted in time relative to the first and second periods for the second PWM inverter. Advantageously, due to the time shifted application of the different switching patterns, different PWM inverters will generate different harmonic current emissions, at least during periods of time where different inverters are operated with different switching patterns. Therefore, within such periods of time, harmonic current emissions will not add up in a cumulative manner as they could if different inverters are operated with the same switching patterns.

The start times, such as the different start times, of the first periods of the first and second PWM inverters are predetermined or determined based on an externally generated trigger signal. Alternatively, the different start times of the first periods of the first and second PWM inverters are determined from a random process.

According to an embodiment, the start time of the first period of the second PWM inverter is delayed relative to the start time of the first period of the first PWM inverter by the time length of the first period of the first PWM inverter. In this way the first and second PWM inverters are operated with different sequences of different switching patterns so that when the first PWM inverter is operated with one switching pattern, the second PWM inverter is operated with a different switching pattern, so that no PWM inverter is operated with the same switching pattern at the same time.

According, to an embodiment, at least the first periods of the first and second PWM inverters have equal lengths. However, to operate different PWM inverters with mutually different switching patterns at any time, all periods should have the same length.

According to an embodiment, in response to a predefined operational condition, such as a grid disturbance event, the method comprises shifting from operating the at least first PWM inverter with the first and second switching patterns, to operating the at least first PWM inverter solely with one of first and second switching patterns.

According to an embodiment, in response to another predefined operational condition, such as a grid recovery event, the method comprises shifting from operating the at least first PWM inverter solely with one of first and second switching patterns, back to operating the at least first PWM inverter with the first and second switching patterns.

The first and second switching patterns may be determined based on respective first and second switching frequencies, wherein the first and second switching frequencies are different.

A second aspect of the invention relates to a PWM controller configured for controlling at least a first PWM inverter, wherein the PWM controller comprises a data processor arranged to perform the method according to the first aspect.

A third aspect of the invention relates to a PWM inverter system comprising
a PWM controller according to the second aspect,
a grid filter for smoothening the voltage output of the PWM inverter, wherein the grid filter is configured for operation, e.g. configured for achieving optimum waveform smoothing, at an operation frequency located between largest magnitude harmonics of the different harmonics of the different switching patterns

A fourth aspect of the invention relates to a wind turbine comprising the PWM inverter system according to the third aspect.

A fifth aspect of the invention relates to an electric power generating plant comprising first and second PWM inverter systems according to the third aspect or one or more wind turbines according to the fourth aspect.

A sixth aspect of the invention relates to a computer program comprising instructions which, when the program is executed by a computer, cause the computer to carry out the method of the first aspect.

In general, the various aspects and embodiments of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1A shows an electric power generating system,

FIG. 1B shows wind power system,

FIG. 1C shows wind turbine comprising a wind power system,

FIG. 2 shows a plurality of PWM controllers of a power generating plant,

FIGS. 3-4 show timing diagrams illustrating methods for controlling PWM inverters.

### DETAILED DESCRIPTION OF AN EMBODIMENT

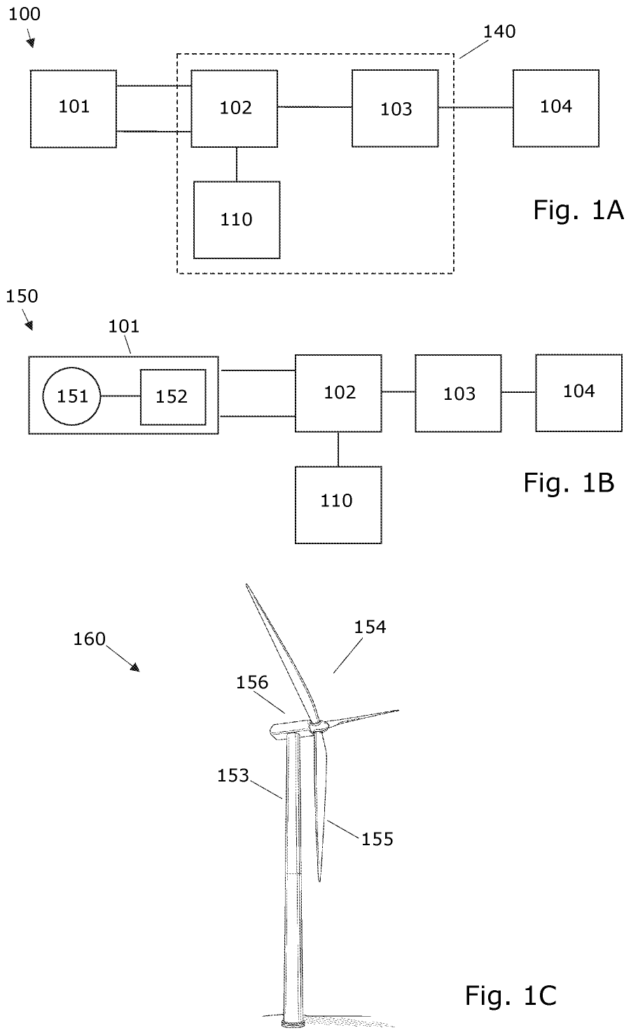

FIG. 1A shows an electric power generating system 100. The electric power generating system 100 comprises a power source 101 which generates a DC power and supplies the DC power to a grid side inverter 102. Herein the grid side inverter 102 is a pulse width modulator (PWM) and is referred to as a PWM inverter 102. The PWM inverter 102 converts the DC power to AC power which is injected to the grid 104, such as an electrical power distribution grid. The AC power from the inverter 102 may be filtered by a grid filter 103. Additionally, transformers may be included, e.g. between the grid filter 103 and the grid 104. The grid filter 103 comprise filter inductors and filter capacitors to provide waveform smoothening of the voltage output of the PWM inverter 102.

While the power from the PWM inverter 102 may be supplied directly to the grid 104, an intermediate power network may be arranged between the PWM inverter 102 and the grid 104 to connect the output of the electric power generating system 100, such as one or more wind turbines, to the grid 104. Such an intermediate network may comprise a power line such as a medium voltage network which connects the power generating system 100 or a plurality of such systems with the grid 104, such as a high voltage power transmission network 104 via a transformer.

Herein the grid 104 can be any of a distribution grid, a transmission grid, a medium voltage network, a high voltage grid or other electrical grid to which the output of the PWM inverter 102 is connected.

The power generating system 100 may be a solar plant such as photovoltaic system, a wind turbine generator, a battery storage system a fuel cell system or any other power generating system which generates a DC output power.

The power generating system 100 further comprises an PWM controller 110 arrange to control the PWM inverter 102 to modulate the DC power into AC power according to a pulse width modulation scheme such as switching pattern.

A PWM inverter system 140, as herein defined, comprises the PWM inverter 102, the PWM controller 110 and the grid filter 103.

FIG. 1B shows an example where the power generating system 100 is a wind power system 150. The power source 101 of the wind power system 150 comprises the generator 151 of the wind turbine and a machine side converter 152 arranged to convert the AC power from the generator into DC power. In general the wind power system 150 comprises at least the PWM controller 110 or at least one PWM inverter system 140.

FIG. 1C shows a wind turbine 160 comprising the wind power system 150. The wind turbine further comprises a tower 153 and a rotor 154 with at least one rotor blade 155, such as three blades. The rotor is connected to a nacelle 156 which is mounted on top of the tower 153 and is arranged to drive the generator 151 situated inside the nacelle via a drive train. The drive train comprises the shaft connecting the rotor 154 with the gearbox or the generator. The rotor 154 is rotatable by action of the wind. The wind induced rotational energy of the rotor blades 155 is transferred via a shaft to the generator. Thus, the wind turbine 150 is capable of converting kinetic energy of the wind into mechanical energy by means of the rotor blades and, subsequently, into electric power by means of the generator. The wind turbine further comprises the machine side converter 152 and the PWM controller and inverter 102, 110.

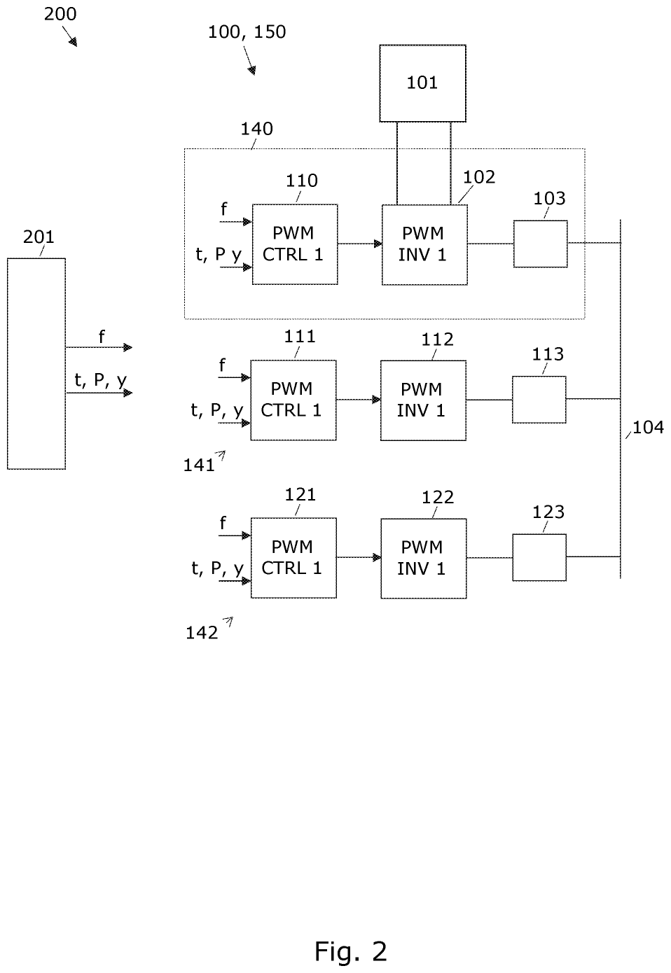

FIG. 2 shows an electric power generating plant 200 comprising one or more electric power generating systems 100 and/or one or more wind power systems 150. For example, the power generating plant 200 may be a wind turbine plant with a plurality of wind turbines 160.

Each of the one or more electric power generating systems 100 such as one or more wind power systems 150 may be configured with one PWM inverter system 140, 141, 142 but it is also possible that a single power generating system 100 may comprise a plurality of PWM inverter systems 140 such as first and second PWM inverter systems 140, 141.

In FIG. 2, each of the PWM inverter systems 140 comprises a PWM controller 110, 111, 121 configured for controlling at least one PWM inverter 102.

The PWM controller 110 comprises a data processor arranged to execute an algorithm based on input data, such as a switching frequency f, start times t, period data P and/or a trigger input y. The input data to different PWM controllers 110, 111, 121 may be supplied and coordinated by a central power plant controller 201.

A single PWM controller 110 need not be limited to control a single PWM inverter 102, but may be configured to control a plurality of PWM inverters such as first and second PWM inverters 102, 112. For example, a single wind turbine 150 may comprise first and second PWM inverters 102, 112, and a single PWM controller 110 arranged for controlling both PWM inverters. Accordingly, a PWM inverter system may comprise one or more PWM inverters 102, 112.

In general, each PWM inverter system 140 comprises a single grid filter 103, 113, 123. A single grid filter may be arranged to filter the power output from one or more PWM inverters, such as first and second PWM inverters 102, 112 comprised by a PWM inverter system. The filtering provides a smoothening the voltage output from the PWM inverter. However, it is also possible that a single PWM inverter system 140 comprises a plurality of grid filters, such as first and second grid filters 103, 113.

The grid filter may be an existing grid filter designed e.g. for a switching frequency located between the first and second switching frequencies. Thus, when the first and second, or further switching frequencies are located not too far from the original switching frequency, the same grid filter may be used without modifications.

As shown, the output from the grid filters 103, 113, 123 are supplied to the grid 104.

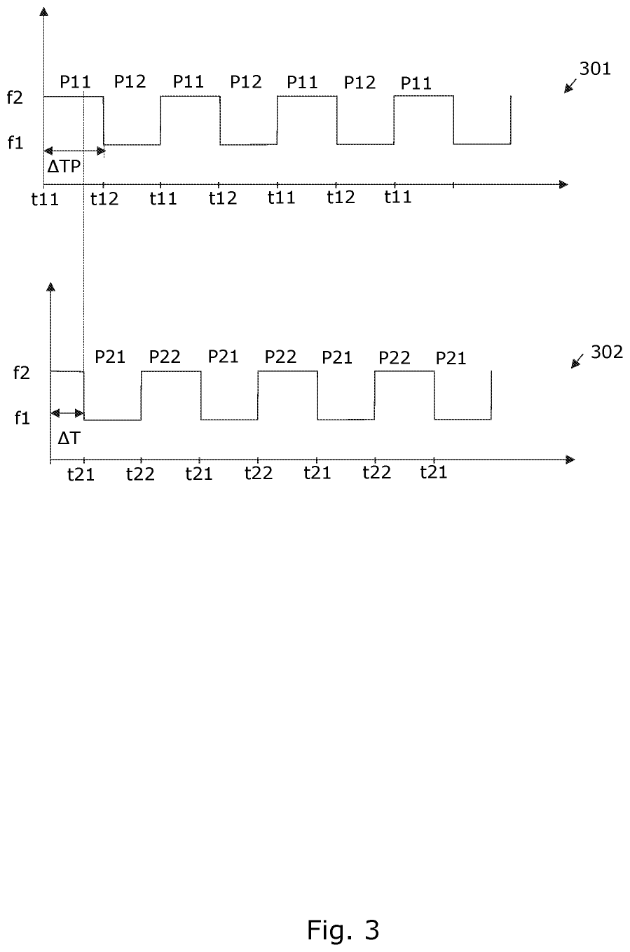

FIG. 3 shows timing diagrams 301, 302 for illustrating examples of methods for controlling of the one or more PWM inverters 102, 112, 122 based on different switching frequencies f1, f2.

The switching frequencies f1, f2 define the frequency of the carrier wave used for modulating the desired voltage reference waveform into a modulating wave or switching pattern which is used for controlling the switches of the PWM inverters 102. The carrier wave may be a triangular wave.

Alternatively, different switching patterns may be predefined and e.g. stored in the PWM controllers 110, 111, 121. It is also possible to determine the switching patterns as needed, e.g. during operation, and store them. For example, switching patterns may be determined using selective harmonic elimination PWM algorithms.

The different switching patterns such as first and second switching patterns generate different harmonic current spectrums when the switching patters are applied to the PWM inverters. The different harmonic current spectrums have different largest magnitude harmonics. The largest magnitude harmonics are the harmonics, i.e. frequencies, of signal components of the switching patterns having the largest voltage or power amplitudes. For explanation purposes, the largest magnitude harmonics corresponds to the different switching frequencies f1, f2. The different switching patterns may be determined based on the respective first and second switching frequencies f1, f2, or any different switching frequencies, e.g. so that the largest magnitude harmonics approaches the different switching frequencies.

Herein examples are explained based on different switching frequencies f1, f2, but could equivalently be based on different switching patterns. Accordingly, any example or description referring to the different switching frequencies f1, f2 are not limited to different switching frequencies, but be based in general on different switching patterns having different largest magnitude harmonics.

The first timing diagram 301 is associated with the first PWM inverter 102. The first timing diagram 301 defines first and second periods P11, P12 defining periods wherein the first PWM inverter 102 is operated based on different first and second switching patterns, equivalently based on first and second switching frequencies f1, f2.

Similarly, the second timing diagram 302 is associated with the second PWM inverter 112. Here the first and second periods P21, P22 similarly define periods wherein the second PWM inverter 112 is operated based on the different first and second switching patterns, equivalently based on first and second switching frequencies f1, f2.

The first and second switching patterns or switching frequencies f1, f2 are used for both the first and second PWM inverters 102, 112.

The first period P11 associated with the first PWM inverter 102 and the first period P21 associated with the second PWM inverter 112 are initiated a start times t11, t21, respectively. The start times t11, t21 of the first and second PWM inverters may be referred to as first and second start times t11, t21.

The first and second start times t11, t21 may be equal, i.e. so that the first and second periods P11, P21 are started at the same time. Alternatively, the first and second start times t11, t21 may be equal, i.e. so that the first and second periods P11, P21 are started at different times. Thus, the second start time t21 may be shifted with a shifting time AT relative to the first start time t11.

In an example, a single PWM inverter such as a first PWM inverter 102 is controlled based on first and second periods P11, P12 and corresponding different first and second switching frequencies f1, f2. As shown the first and second periods P11, P12 are applied alternately.

As illustrated, the second PWM inverter 112 may be controlled according to first and second periods P21, P22 which are time shifted relative to the first and second periods P11, P12 of the first PWM inverter 102 by shifting time ΔT.

With a shifting time ΔT=0, the start times t11, t21 of the first periods P11, P21 are equal. Accordingly, the first and second PWM inverters 102, 112 are operated with the same switching frequencies. In this case the harmonic current emission of the first and second PWM inverters 102 is spread over different spectra when measured over a period which at least is longer than one of the first periods P11, P21.

With a shifting time ΔT>0, but less than the length of one of the first periods P11, P21, then at least for some period of time, i.e. during periods where the first PWM inverter 102 is operated with one switching frequency f1 while the second PWM inverter 112 is operated with another switching frequency f2, equal switching frequencies or equal largest harmonics do not add up to the same level as if all PWM inverters were operated with non-shifted cycles of the different switching frequencies or switching patterns. Thus, by starting the first period P11 of the first PWM inverter and the first period P21 of the second PWM inverter at different start times t11, t21 it is possible to reduce the cumulative emission of harmonic current emissions from a plurality of PWM inverters at a given moment in time and not only over a period of time.

A special case occurs when with the shifting time ΔT=ΔTP, where ΔTP is the length of the first periods P11 and all periods of the first and second PWM inverters 102, 112 are equal. In this case, the first and second PWM inverters are operated with mutually different switching frequencies or different switching patterns at any time. Thus, by delaying the start time t21 of the first period P21 of the second PWM inverter 112 relative to the start time t11 of the first period P11 of the first PWM inverter 102 by the time length ΔTP of the first period P11 of the first PWM inverter, first periods P11 of the first PWM inverter 102 are run simultaneously with second periods P22 of the second PWM inverter 112 and second periods P12 of the first PWM inverter 102 are run simultaneously with first periods P21 of the first PWM inverter 102.

The start times t11, t21 of the first periods P11, P21 of the first and second PWM inverters, the start times t11, t22 of the respective first and second periods P11, P22 of the of the first and second PWM inverters, or the start times t12, t21 of the respective second and first periods P12, P21 of the of the first and second PWM inverters may be predetermined or determined based on a common externally generated trigger signal. For example, predetermined timer signals t may be supplied by the central power plant controller 201 to the PWM controllers 110, 111, 121, wherein the timer signal comprises the start times t11, t12, t21, t22 of the different periods P11, P12, P21, P11. Alternatively, an externally generated trigger signal, such as a commonly generated trigger signal y from the power plant controller 201 may be supplied to the PWM controllers 110, 111, 121, wherein the PWM controllers are configured to determine the timing of changing between the periods P11, P12, etc., i.e. the changing between different switching frequencies f1, f2. For example, the PWM controllers 110, 111, may comprise an internal timer for determining shifts between switching frequencies or switching patterns.

Similarly, the central power plant controller 201 may supply period information P, such as period lengths of the first and second periods P11, P12, P21, P22, the PWM controllers.

It is also possible that the start times t11, t21 of the first periods P11, P21 of the first and second PWM inverters are determined by a random generator comprised by each of the PWM controllers 110, 111, 121. Subsequent changes in the switching frequencies may be determined relative to the randomly determined start times by an internal timer.

In general, different PWM inverters may be controlled based on sequence of different switching frequencies applied in a sequence of periods, of different or equal lengths, with one distinguishable switching frequency for each period. The sequence of periods may be shifted in time for different PWM inverters so that two or more PWM inverters are operated with different switching frequencies at a given time. The time shift may be equal to or less than one period. In general, the the periods for operating the first and second PWM inverters with different switching periods may have the same length, but may also have different lengths, or randomly varying lengths.

The length of any of the first periods P11, P21 and/or the second periods P12, P22, or in general periods wherein the PWM converters are operated with distinguishable and mutually different switching frequencies should be longer than a plurality of the fundamental periods of the grid frequency. For example, the length of the periods should be longer than 0.1 seconds, such as longer than 1 minute, longer than 2 minutes or even longer than 4 minutes.

The switching frequencies may be selected so that the difference between the first and second switching frequencies f1, f2, or in general the difference between different switching frequencies or different largest magnitude harmonics is at least 100 Hz, such as at least 200 Hz, e.g. 400 Hz.

The power plant controller 201 may be configured to stop operating the PWM inverters with different switching frequencies in response to a predefined operational condition, such as a grid disturbance event. In this case, the PWM inverters will be operated solely with one of first and second switching frequencies or switching patterns. Similarly, the power plant controller 201 may be configured to automatically return to operating the PWM inverters with different switching frequencies in response to detecting another predefined operational condition, such as a grid recovery event.

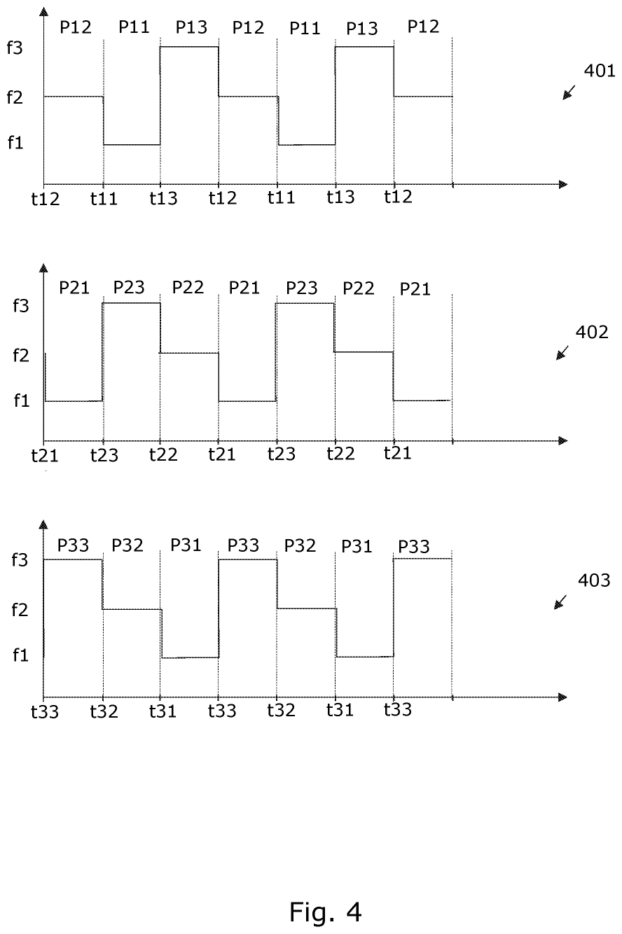

FIG. 4 shows timing diagrams 401-403 for illustrating control of the one or more PWM inverters 102, 112, 122 based on three different switching frequencies f1, f2, f3.

Thus, as shown in FIG. 4, a PWM converter 102 may alternatively be controlled based on three are more periods P11, P12, P13 with associated different switching frequencies f1, f2, f3 wherein the first, second and third periods are applied in succession and continually repeated with the same pattern of the different switching frequencies.

Due to the successively applied periods P11, P12, P13 with different switching frequencies, the harmonic current emission of the PWM 102 is spread over different spectra when measured over a period which at least is longer than the first period P11. The largest amplitude harmonic during the different periods May be the actual switching frequency of the different switching frequencies. Similarly, for the case with different switching patterns, the harmonic current emission of the PWM 102 will spread over the different spectra and the largest amplitude harmonic during the different periods will change according to the different largest amplitude harmonics.

1. A method for controlling at least first and second PWM inverters, the method comprises:
determining first and second periods of the first PWM inverter for operating the first PWM inverter with respective first and second switching patterns wherein the first and second switching patterns have different harmonic spectrums, and
operating the first PWM inverter with the first and second switching patterns applied successively during the respective first and second periods
determining first and second periods of the second PWM inverter for operating the second PWM inverter with the respective first and second switching patterns, and
operating the second PWM inverter with the first and second switching patterns applied successively during the respective first and second periods of the second PWM inverter, wherein
the first period of the first PWM inverter and the first period of the second PWM inverter are started at different start times.

2. The method according to claim 1, wherein the start times of the first periods of the first and second PWM inverters are predetermined or determined based on an externally generated trigger signal.

3. The method according to claim 1, wherein the start time of the first period of the second PWM inverter is delayed relative to the start time of the first period of the first PWM inverter by the time length of the first period of the first PWM inverter.

4. The method according to claim 1, wherein the different start times of the first periods of the first and second PWM inverters are determined from a random process.

5. The method according to claim 1, wherein at least the first periods of the first and second PWM inverters have equal lengths.

6. The method according to claim 1, wherein in response to a predefined operational condition, such as a grid disturbance event, the method comprises shifting from operating the at least first PWM inverter with the first and second switching patterns, to operating the at least first PWM inverter solely with one of the first and second switching patterns.

7. The method according to claim 6, wherein in response to another predefined operational condition, such as a grid recovery event, the method comprises:
shifting from operating the at least first PWM inverter solely with one of the first and second switching patterns, back to operating the at least first PWM inverter with the first and second switching patterns.

8. The method according to any of the preceding claim 1, wherein the first and second switching patterns are determined based on respective first and second switching frequencies, wherein the first and second switching frequencies are different.

9. A plurality of PWM controllers configured for controlling at least a first and a second PWM inverter, wherein the PWM controllers comprises a data processor arranged to perform an operation, comprising:
determining first and second periods of the first PWM inverter for operating the first PWM inverter with respective first and second switching patterns wherein the first and second switching patterns have different harmonic spectrums, and
operating the first PWM inverter with the first and second switching patterns applied successively during the respective first and second periods;
determining first and second periods of the second PWM inverter for operating the second PWM inverter with the respective first and second switching patterns;
operating the second PWM inverter with the first and second switching patterns applied successively during the respective first and second periods of the second PWM inverter;
wherein the first period of the first PWM inverter and the first period of the second PWM inverter are started at different start times.

10-12. (canceled)

13. A computer program comprising instructions which, when the program is executed by a computer, cause the computer to carry out an operation for controlling at least a first and a second PWM inverter, comprising:
determining first and second periods of the first PWM inverter for operating the first PWM inverter with respective first and second switching patterns wherein the first and second switching patterns have different harmonic spectrums, and
operating the first PWM inverter with the first and second switching patterns applied successively during the respective first and second periods;
determining first and second periods of the second PWM inverter for operating the second PWM inverter with the respective first and second switching patterns;
operating the second PWM inverter with the first and second switching patterns applied successively during the respective first and second periods of the second PWM inverter;
wherein the first period of the first PWM inverter and the first period of the second PWM inverter are started at different start times.

14. The plurality of PWM controllers of claim 9, further comprising:
a grid filter for smoothening the voltage output from the PWM inverter, wherein the grid filter is configured for operation at an operation frequency located between largest magnitude harmonics of the different harmonics of the different switching patterns.
